(19) United States
(12) Patent Application Publication
(10) Pub. No.: US 2010/0308948 A1
(43) Pub. Date: Dec. 9, 2010

(54) Ferrite core assembly

(75) Inventors: Paul Chapman, Sharpthorne (GB); Gareth Timothy Shelley, Woodingdean (GB)

Correspondence Address: ABELMAN, FRAYNE & SCHWAB, 666 THIRD AVENUE, 10TH FLOOR, NEW YORK, NY, 10017, US

(73) Assignee: Technetix Group Limited

(21) Appl. No.: 12/802,105

(22) Filed: May 27, 2010

Related U.S. Application Data
(60) Provisional application No. 61/183,624, filed on Jun. 3, 2009.

(51) Int. Cl. H01F 27/24

(52) U.S. Cl. 336/212

(57) ABSTRACT

There is provided a ferrite core assembly comprising a plurality of ferrite elements and a plurality of spacer elements, wherein each spacer element comprises formations for engaging with two ferrite elements, thereby to locate the ferrite elements with respect to each other. Various embodiments of the spacer element are described with one spacer element formed with a spigot extending from each face that adjoins a ferrite element. The spacer element can include gripping protrusions, to grip an external surface of a ferrite rod or ferrite bead, or an internal surface of a ferrite bead. There is also provided broadband and cable network equipment incorporating a ferrite core assembly comprising a plurality of ferrite elements and a plurality of spacer elements, wherein each spacer element comprises formations for engaging with two ferrite elements, thereby to locate the ferrite elements with respect to each other.

### CROSS REFERENCE TO RELATED APPLICATIONS

This patent application claims the benefit of U.S. Provisional Application, Ser. No. 61/183,624, filed Jun. 3, 2009, the contents of which are incorporated by reference herein in its entirety.

### FIELD OF THE INVENTION

This invention relates to a ferrite core assembly used within transformers and to a spacer element used in such an assembly.

### BACKGROUND TO THE INVENTION

Ferrite rods are often inserted into open wound inductors, such as coils, to increase the effective inductance of the coil allowing smaller coils to be used. However, under high current conditions, the ferrite induces high frequency RF signals known as hum and this can cause interference in electrical signals. In an attempt to reduce the “hum”, manufacturers split the ferrite rods into shorter lengths and use plastics spacers to keep them apart. To keep the rods and spacers together in a way that they can be easily inserted into the coil, a plastic sheath is placed over the rod/spacer assembly, typically by using a heat-shrinkable plastics sheath.

### SUMMARY OF THE INVENTION

In accordance with one aspect of the present invention, there is provided a ferrite core assembly comprising a plurality of ferrite elements and a plurality of spacer elements, wherein each spacer element comprises formations for engaging with two ferrite elements, thereby to locate the ferrite elements with respect to each other. By having formations that engage with ferrite elements either side of it, the spacer element ensures that forming the assembly is easier as ferrite elements and spacer elements are in registration with each other and are not freely moveable. The ferrite elements are typically in the form of solid cylinders or hollow cylinders known as beads, of suitable dimensions to fit within a transformer core.

The invention also lies in a spacer element for use within a ferrite rod assembly, the spacer element comprising formations capable of engaging with ferrite elements in the form of substantially cylindrical rods.

Preferably the or each spacer element is made from an insulating material, such as plastics material, typically Acrylonitrile Butadiene Styrene (ABS) plastics, with the material desirably a thermo-setting plastic suitable for injection moulding.

The or each spacer element may be in the form of a circular disc, with typically the same diameter as the ferrite elements, so that when the assembly is placed within a transformer core, the assembly substantially fills the internal volume bounded by the core.

The formations of the or each spacer element may be provided in a number of different configurations. In a particularly preferred embodiment, the spacer element may be formed with a spigot extending from each face that adjoins a ferrite element. Typically these spigots will extend along the central axis of the spacer element so as to be coaxial with and engage with a channel or depression within the ferrite element. This form of spacer element is particularly suitable for use with ferrite elements in the form of hollow cylindrical rods, otherwise known as beads.

Alternatively the spacer element may be formed with a recess in each face that is to adjoin a ferrite element, each recess receiving and engaging with the ferrite element or protrusions on the ferrite elements. This form of spacer element is particularly useful for ferrite elements manufactured as solid cylindrical rods.

The spacer element may comprise gripping protrusions, to grip an external surface of a ferrite rod or ferrite bead, or an internal surface of a ferrite bead.

In accordance with another aspect of the invention, there is provided broadband and cable network equipment incorporating a ferrite rod assembly as aforesaid.

The invention will now be described, by way of example, with reference to the accompanying drawings in which:

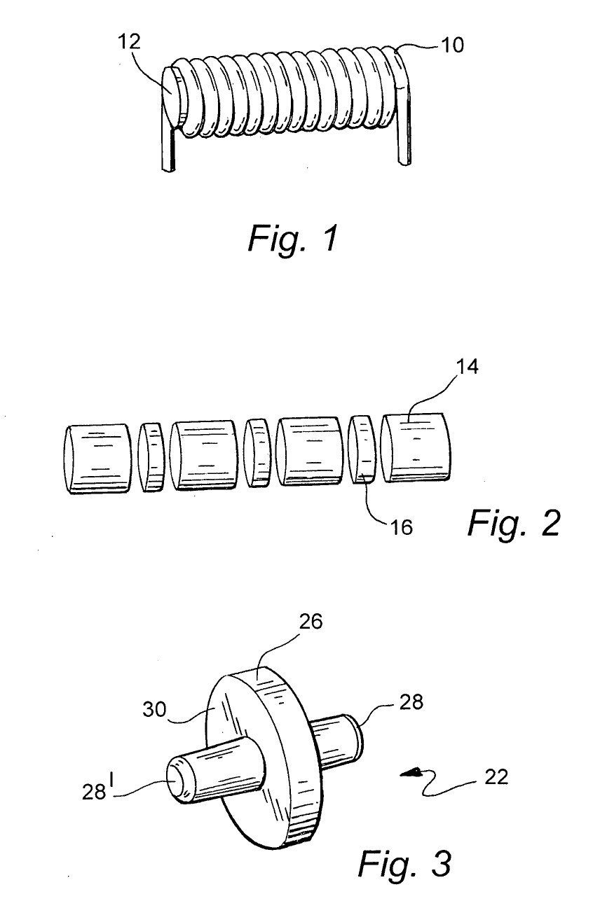

FIG. 1 shows an open wound coil with a single ferrite rod;

FIG. 2 shows an exploded view of a prior art ferrite core assembly;

FIG. 3 shows a spacer element in accordance with the invention;

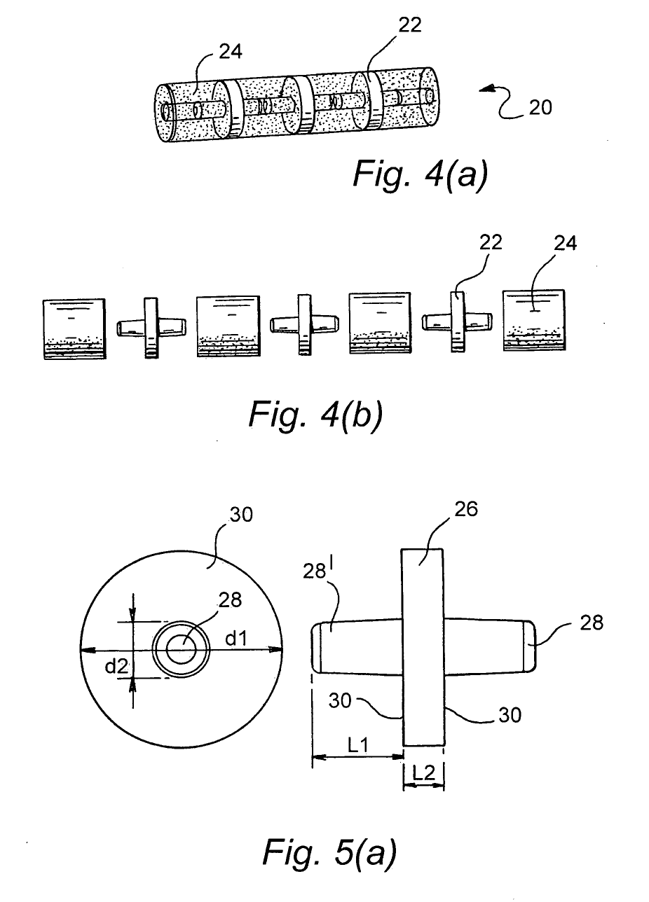

FIG. 4(a) shows a ferrite bead/stacking spacer assembly in accordance with the present invention with FIG. 4(b) showing the assembly in exploded view;

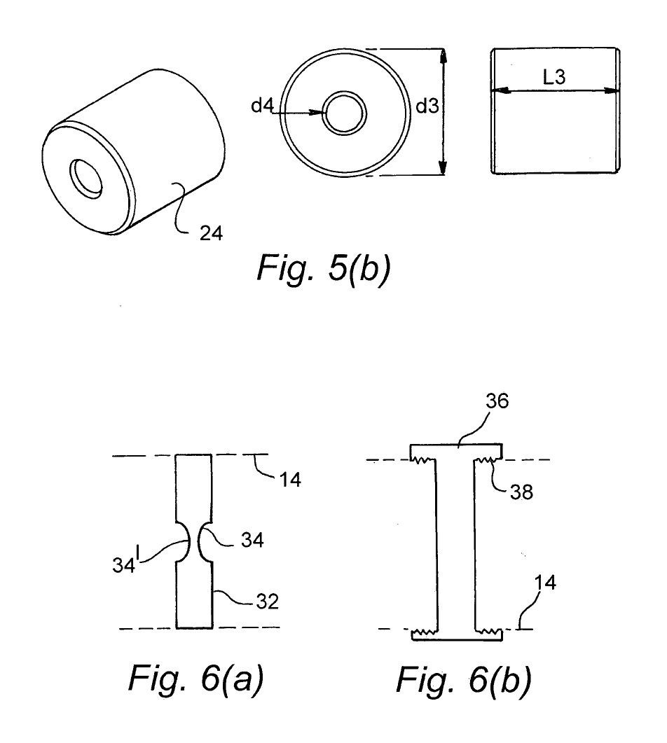

FIG. 5(a) shows the relative dimensions of a spacer element when compared to the relative dimensions of a ferrite bead, shown in FIG. 5(b); and

FIG. 6 shows different embodiments of the spacer element.

### DESCRIPTION

In CATV and broadband systems using coaxial cable networks, amplifiers and other active equipment are often line powered. This is achieved by combining the low frequency (50 Hz-60 Hz) AC power signal with the CATV data signal stream over the same coaxial cable. When a cable carrying the combined data and power is connected to a piece of network equipment, power bypass circuits are used inside the equipment to separate the AC power signal from the data at the input and re-combine them at a designated output. Open wound inductors or coils with a wire diameter typically 0.5 mm-2.0 mm are commonly used in power bypassing circuits in CATV equipment.

As space is limited in this equipment, ferrite rods 12 are inserted inside the coils 10, see FIG. 1, which greatly increases the effective inductance of the coil allowing smaller coils to be used.

Under high current conditions, the ferrite induces higher frequency RF signals known as “hum” in the power passing circuits which, when recombined with the CATV signal causes interference. In order to reduce the “hum”, and as shown in FIG. 3, manufacturers split the ferrite rods into shorter lengths 14 and use small plastic spacers 16 to keep them apart.

However this core assembly is difficult to assemble whilst retaining all the parts inside the coil. To solve this, a plastic sheath is placed over the rod/spacer assembly before it is placed inside the coil, a process which is time consuming.

FIGS. 3 and 4 show a ferrite core assembly 20 in accordance with the present invention, with a plastics spacer 22 shown in perspective view in FIG. 3. FIG. 4(a) shows the assembled rod and spacer assembly, with the rods 14 shown as partially transparent so that the engagement of the spacer 22 with the ferrite beads 24 can be seen, the individual elements being shown in exploded view in FIG. 4(b). The spacer 22 is a thin disc 26 made from ABS plastics integrally moulded with a single spigot 28, 28′ extending from each face 30. By means of location of the spigots 28, 28′ within a hollow core of a bead or an indentation or depression within a rod, the spacer 22 acts to locate with respect to each other two ferrite elements either side of the spacer. This stacking spacer 22 with a central spigot 28, 28′ on each face 30 enables the ferrite elements 14, 24 to be quickly assembled into desired lengths and holds the ferrite elements in registration with each other whilst the combined assembly 20 is either inserted directly into an inductor coil or as a heat-shrink plastics sheet applied.

The spacer 22 is shown in plan and side view in FIG. 5(a), with a ferrite bead 24 shown in FIG. 5(b). The relative dimensions of the spacer element 22 with spigots and ferrite bead 24 are determined as follows:
d1 Outer diameter of spacer ≦d3 Outer diameter of ferrite bead
d2 spigot diameter ≦d4 diameter of hole in ferrite bead
L1 Length of spigot ≦½ L3 length of ferrite bead

The thickness of the spacer, distance L2, is determined by the design of the inductor coil. The distance between the beads and the material the spacer is made from affect the overall performance of the inductor. L2 could be any maximum length but the minimum will be determined by the material the spacer is made from whereby it still retains sufficient mechanical stability for the spigots to hold the beads in place, and typically L2 ranges from 20 mm to 0.1 mm. The spigot length typically ranges from 50 mm to 1 mm.

For a particularly preferred example L1 is 2.4 mm, L2 0.7 mm, L3 5 mm, d1 5mm, d2 1.45 mm, d3 5 mm and d4 1.5 mm.

FIG. 6 shows two alternative embodiments of the spacer, with the position of the ferrite element 14 indicated in dashed lines. FIG. 6(a) shows a side view of a spacer disc 32 with semi-circular depressions 34, 34′ in each face. This spacer is particularly applicable for solid ferrite rods made with a co-operating formation which engages the recess. FIG. 6(b) shows a side view of a spacer with gripping teeth 38, these teeth being resilient and gripping a ferrite element 14. The central spigot 28, 28′ described in relation to the spacer shown in FIG. 3 can similarly be provided with gripping teeth on the outer surface of the spigot, if required.

1. A ferrite core assembly comprising a plurality of ferrite elements and a plurality of spacer elements, wherein each spacer element comprises formations for engaging with two ferrite elements, thereby to locate the ferrite elements with respect to each other.

2. A ferrite core assembly according to claim 1, wherein the spacer element is formed with a spigot extending from each face that adjoins a ferrite element.

3. A ferrite core assembly according to claim 1, wherein the spacer element is formed with a recess in each face that adjoins a ferrite element.

4. A ferrite core assembly according to claim 1, wherein the spacer element further comprises gripping protrusions, to grip an external surface of a ferrite rod or ferrite bead, or an internal surface of a ferrite bead.

5. A ferrite core assembly according to claim 2, wherein the spacer element further comprises gripping protrusions, to grip an external surface of a ferrite rod or ferrite bead, or an internal surface of a ferrite bead.

6. A ferrite core assembly according to claim 3, wherein the spacer element further comprises gripping protrusions, to grip an external surface of a ferrite rod or ferrite bead, or an internal surface of a ferrite bead.

7. A spacer element for use within a ferrite rod assembly, the spacer element comprising formations capable of engaging with ferrite elements in the form of substantially cylindrical rods.

8. A spacer element according to claim 7, wherein the spacer element is formed with a spigot extending from each face that adjoins a ferrite element.

9. A spacer element according to claim 7, wherein the spacer element is formed with a recess in each face that adjoins a ferrite element.

10. A spacer element according to claim 7, wherein the spacer element further comprises gripping protrusions, to grip an external surface of a ferrite rod or ferrite bead, or an internal surface of a ferrite bead.

11. A spacer element according to claim 8, wherein the spacer element further comprises gripping protrusions, to grip an external surface of a ferrite rod or ferrite bead, or an internal surface of a ferrite bead.

12. A spacer element according to claim 9, wherein the spacer element further comprises gripping protrusions, to grip an external surface of a ferrite rod or ferrite bead, or an internal surface of a ferrite bead.

13. Broadband and cable network equipment incorporating a ferrite core assembly comprising a plurality of ferrite elements and a plurality of spacer elements, wherein each spacer element comprises formations for engaging with two ferrite elements, thereby to locate the ferrite elements with respect to each other.

14. Broadband and cable network equipment according to claim 13, wherein the spacer element is formed with a spigot extending from each face that adjoins a ferrite element.

15. Broadband and cable network equipment according to claim 13, wherein the spacer element is formed with a recess in each face that adjoins a ferrite element.

16. Broadband and cable network equipment according to claim 13, wherein the spacer element further comprises gripping protrusions, to grip an external surface of a ferrite rod or ferrite bead, or an internal surface of a ferrite bead.

17. Broadband and cable network equipment according to claim 14, wherein the spacer element further comprises gripping protrusions, to grip an external surface of a ferrite rod or ferrite bead, or an internal surface of a ferrite bead.

18. A ferrite core assembly according to claim 15, wherein the spacer element further comprises gripping protrusions, to grip an external surface of a ferrite rod or ferrite bead, or an internal surface of a ferrite bead.
